(19) United States
(12) Patent Application Publication
(10) Pub. No.: US 2005/0212241 A1
(43) Pub. Date: Sep. 29, 2005

(54) Modular mobile cart

(76) Inventor: James Donald Todd Stone, Markham (CA)

Correspondence Address: Gowling Lafleur Henderson LLP, Commerce Court West, Suite 4900, Toronto, ON, M5L 1J3, CA

(21) Appl. No.: 11/030,989

(22) Filed: Jan. 10, 2005

(30) Foreign Application Priority Data
Jan. 9, 2004 (CA) 2,455,051

(51) Int. Cl. B62B 5/00

(52) U.S. Cl. 280/79.3

(57) ABSTRACT

A mobile cart includes a first frame, and a second frame. The first frame includes a first base, first mover means coupled to the first base for providing mobility to the first frame, and a first upright support frame extending upwardly from the first base for supporting a first top, the first support frame including first engagement means. The second frame includes a second base, second mover means coupled to the second base for providing mobility to the second frame, and a second upright support frame extending upwardly from the second base for supporting a second top. The second support frame includes second engagement means cooperating with the primary engagement means for securing the second frame to the primary frame.

### FIELD OF THE INVENTION

The present invention relates to a mobile cart. In particular, the present invention relates to an extensible cart which can be field-modified in size and/or shape. This application claims priority from Canadian application no. 2,455,051.

### BACKGROUND OF THE INVENTION

Mobile carts are commonly used in warehouses for transporting articles of manufacture between loading/shipping bays and storage areas. Further, mobile carts are often equipped with bar-code readers and printers to allow such articles to be readily catalogued prior to storage and shipment. Also, mobile carts have been equipped with cash register terminals for use as check-out desks.

Despite the widespread use of such carts, a common problem is that they tend to fixed in size and shape. Consequently, the cart manufacturer must maintain a variety of different designs to satisfy the varying needs of its customers. Conversely, if a cart customer's needs change, the customer must purchaser a new line of carts, even if the required change is only slight. Further, there may be several months lead time between the date a new design is requested and the date the redesigned cart is delivered to the customer. Accordingly, attempts have been made to design a mobile cart that in can be field-modified by the customer in response to the customer's changing needs.

For instance, McCoy (U.S. Pat. No. 5,309,823), Chang (U.S. Pat. No. 5,299,817), Hodges (U.S. Pat. No. 5,599,031), Oefelein (U.S. Pat. No. 6,042,219) and Leverington (U.S. Pat. No. 6,263,031) developed extensible carts which are field-adaptable in size to the article to be transported. However, each extensible cart uses telescoping frame members to allow the size of the cart to be altered, thereby increasing the manufacturing cost and weight of the cart, and reducing its maneuverability. Further, clearance must be maintained between the telescoping frame members to allow the frame members to slide relative to one another, thereby compromising the rigidity of the cart, and reducing its load-carrying capacity. Therefore, the remains a need for a mobile cart that in can be easily field-modified by the customer in response to the customer's changing needs.

### SUMMARY OF THE INVENTION

According to the present invention, there is provided a mobile cart of modular design, which allows the size and shape of the cart to be modified by adding or removing frame components as required.

In accordance with a first aspect of the invention, the mobile cart includes a base; mover means coupled to the base for providing mobility to the cart; a top; and a support frame extending upwardly from the base and supporting the top. The upright support frame includes engagement means for securing an auxiliary cart to the mobile cart.

In accordance with a second aspect of the invention, the mobile cart includes a first frame, and a second frame. The first frame includes a first base, first mover means coupled to the first base for providing mobility to the first frame, and a first upright support frame extending upwardly from the first base for supporting a first top, the first support frame including first engagement means. The second frame includes a second base, second mover means coupled to the second base for providing mobility to the second frame, and a second upright support frame extending upwardly from the second base for supporting a second top. The second support frame includes second engagement means cooperating with the primary engagement means for securing the second frame to the primary frame.

In one implementation of the invention, the first engagement means comprises a pair of stops, one of the stops being disposed adjacent the first base, the other of the stops being disposed adjacent the first top. The second engagement means comprises a pair of shoulders, one of the shoulders being disposed adjacent the second base, the other of the shoulders being disposed adjacent the second top, the shoulders pressing against the stops for securing the second frame to the first frame. The stops are positioned at opposite ends of the first upright support frame, and the shoulders are positioned at opposite ends of the second upright support frame, the shoulders being disposed between the stops. Also, the stops and the shoulders extend outwardly from the respective upright support frames, substantially parallel to the base.

Preferably, the first frame has a substantially parallelopiped shape, the first base has four corners, and the first mover means comprises a caster wheel disposed at each respective corner. Each upright support frame comprises four elongate frame members, each said frame member including a plurality of parallel slots extending substantially parallel to the respective base for supporting movable shelving therein.

Also, each shoulder is formed on a respective substantially horizontally-extending second stud panel, the second stud panels being secured to a pair of the respective elongate frame members. An uppermost one of the second stud panels is configured for removably securing the second top thereto, and a lowermost one of the stud panels including a channel for supporting a portion of the second base.

Similarly, each stop is formed on a respective substantially horizontally-extending first stud panel, the first stud panels being secured to a pair of the respective elongate frame members. An uppermost one of the first stud panels is configured for removably securing the first top thereto, and the second top is substantially coplanar with the first top. The first and second tops comprise board facia paneling.

Preferably, the upright support frames include a panel mounting bracket fastened thereto for securing substantially vertically-extending side facia paneling to the support frames. The facia paneling includes a mounting plate fastened thereto for removably securing the paneling to the respective panel mounting bracket.

### BRIEF DESCRIPTION OF THE DRAWINGS

The preferred embodiments of the invention will now be described, by way of example only, with referenced to the accompanying drawings, in which:

FIG. 1 is a perspective view of one embodiment of the mobile cart, depicting the first frame, the second frame, and a shelf secured to the first frame;

FIG. 2 includes front and side plan views of the mobile cart shown in FIG. 1;

FIG. 3 includes perspective, plan and end views of a top panel mounting bracket of the upright support frames of the first and second frames;

FIG. 4 includes perspective, plan and end views of a back panel mount for interconnecting the elongate frame members of the upright support frames;

FIG. 5 includes perspective, plan and end views of a side panel mounting bracket of the upright support frames;

FIG. 6 is a perspective view of the second frame depicted in FIG. 1;

FIG. 7 includes front, side and bottom plan views and end views of the second frame depicted in FIG. 6;

FIG. 8 includes perspective, plan and end views of the base of the second frame;

FIG. 9 includes perspective, plan and end views of one of the end frame assemblies of the second frame;

FIG. 10 includes perspective, plan and end views of one the elongate frame members of the end frame assembly shown in FIG. 9;

FIG. 11 includes perspective, plan and end views of one of the horizontal stud members of the end frame assembly shown in FIG. 9;

FIG. 12 includes perspective, plan and end views of the other end frame assembly of the second frame;

FIG. 13 includes perspective, plan and end views of the upper horizontal stud member of the end frame assembly shown in FIG. 12;

FIG. 14 includes perspective, plan and end views of one the elongate frame members of the end frame assembly shown in FIG. 12;

FIG. 15 includes perspective, plan and end views of the lower horizontal stud member of the end frame assembly shown in FIG. 12;

FIG. 16 is a perspective view of the first frame and the shelf depicted in FIG. 1;

FIG. 17 includes front and side plan views of the first frame depicted in FIG. 16;

FIG. 18 includes perspective, plan and end views of the shelf depicted in FIG. 16;

FIG. 19 includes perspective, plan and end views of the base of the first frame;

FIG. 20 includes perspective, plan and end views of side facia paneling for attachment to the first and second frames;

FIG. 21 includes perspective, plan and end views of top facia paneling for attachment to the first and second frames; and

FIG. 22 is a perspective view of another embodiment of the mobile cart, depicting the first frame and shelf shown in FIG. 1, and a modified (narrower) second frame.

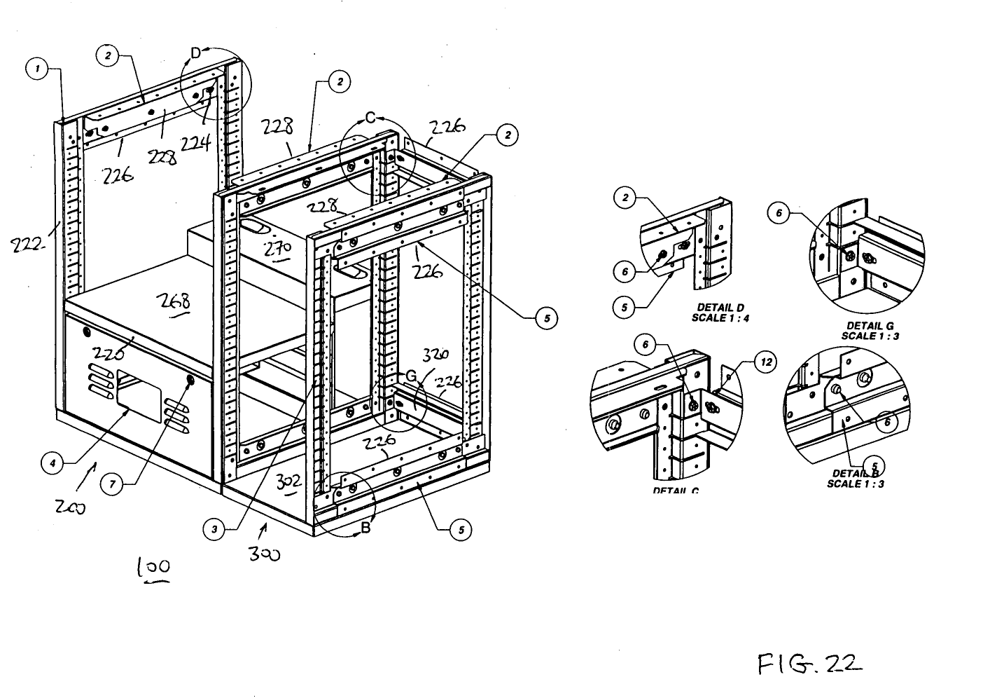

### DETAILED DESCRIPTION OF THE PREFERRED EMBODIMENT

Mobile Cart 100

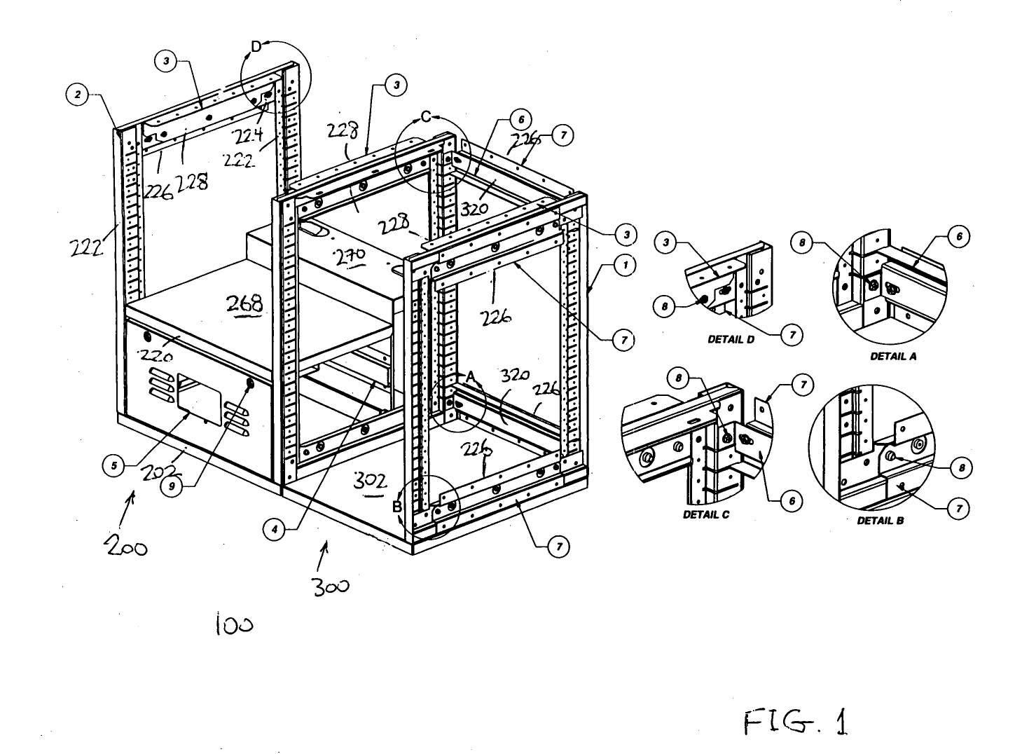

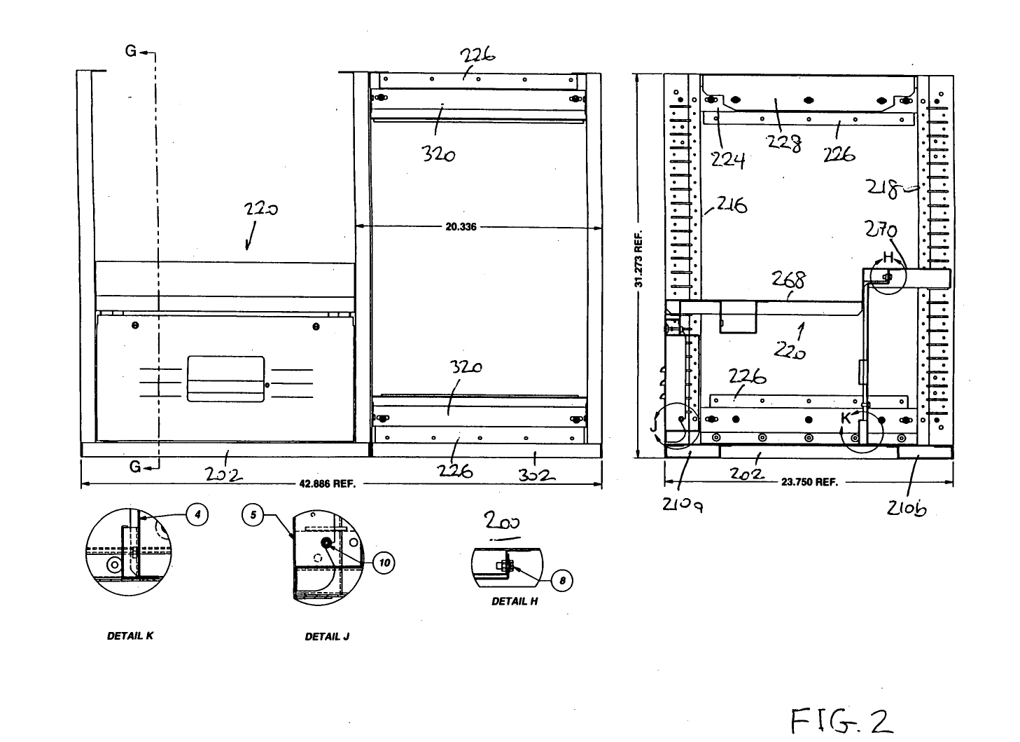

Turning to FIGS. 1 and 2, a mobile cart, denoted generally as 100, is shown comprising a first frame 200, and a second frame 300 secured to the first frame 200. Preferably, the first and second frames 200, 300 are stamped from steel, although other materials and manufacturing techniques may be used. As shown, the first frame 200 is secured to the left of the second frame 300, however in one variation (not shown), the first frame 200 is secured to the right of the second frame 300.

First Frame 200

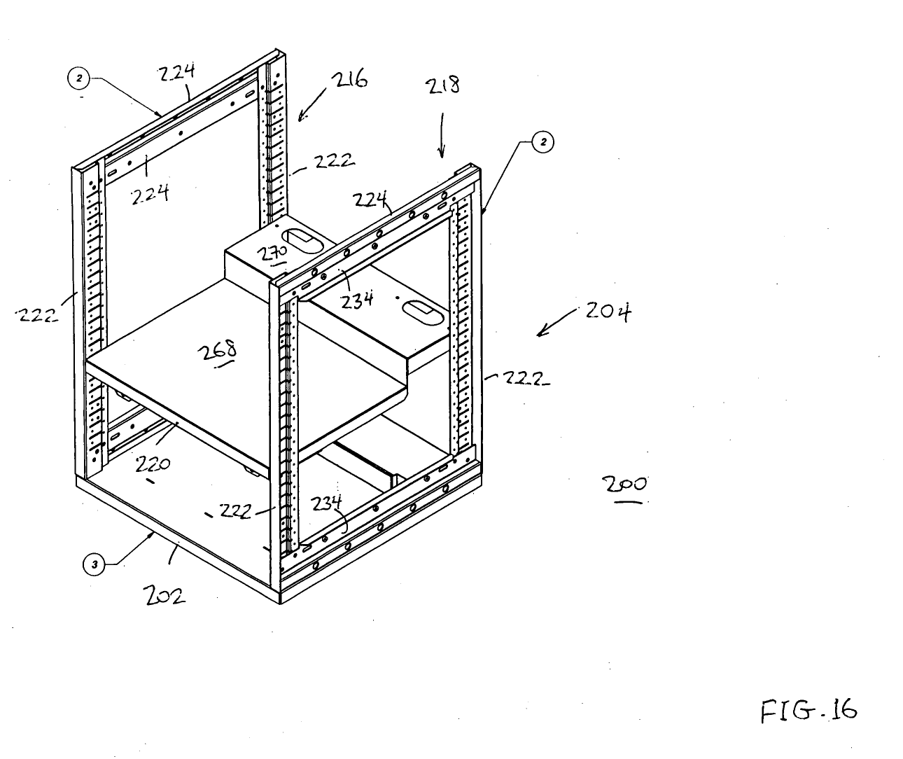

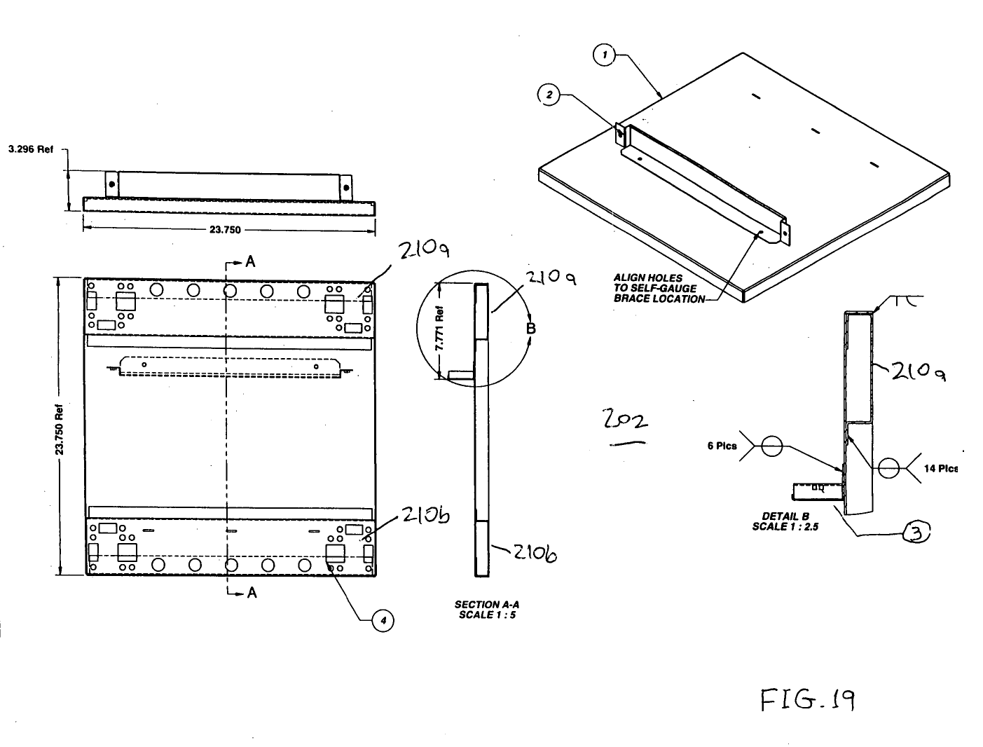

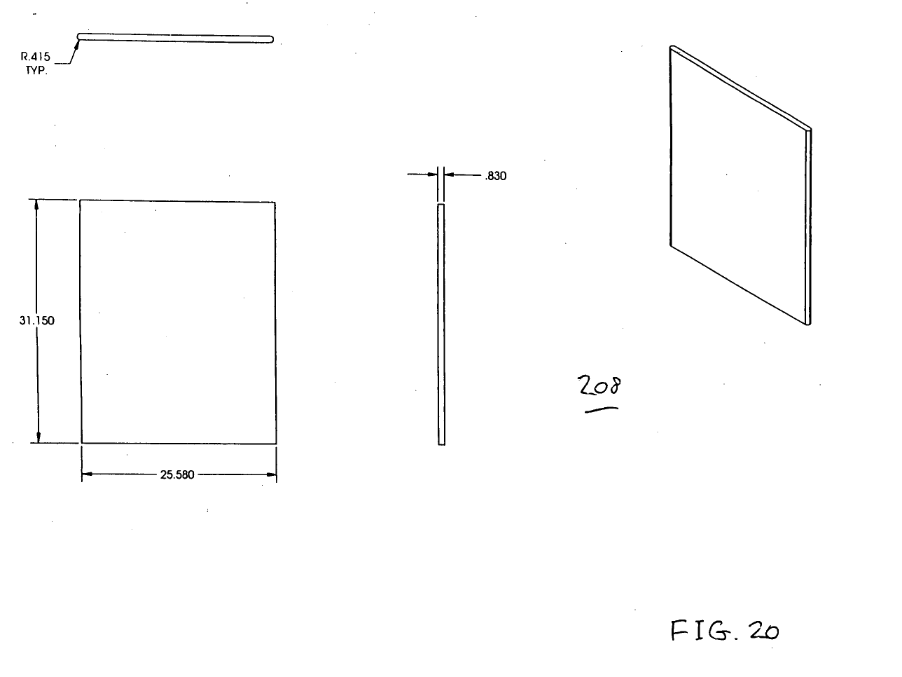

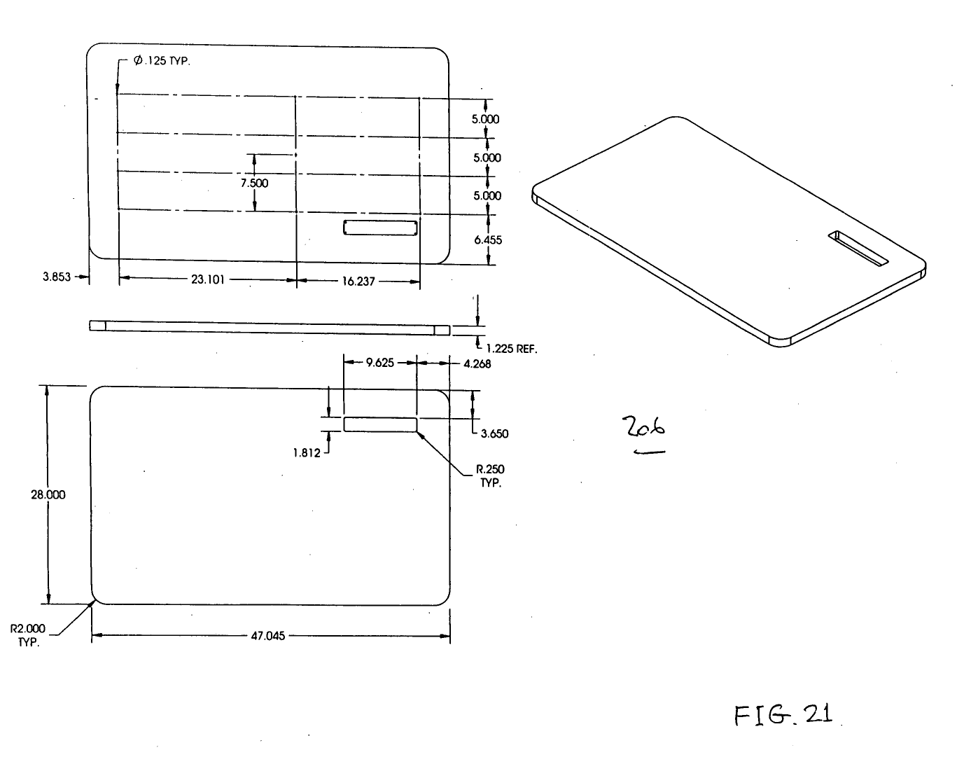

The first frame 200 includes a first base 202, and a first upright support frame 204 extending upwardly from the first base 202 for supporting a top 206 (see FIG. 21) and vertically-extending side/rear panels 208 (see FIG. 20). The first base 202 is shown in detail in FIG. 19, and the first upright support frame 204 is shown in detail in FIG. 16.

Preferably, the first frame 200 has a substantially parallelopiped shape, and the first base 202 has a substantially rectangular shape. Alternately, however, the first base 202 and the first frame 200 may have a different shape to impart a different appearance to the first frame 200. For instance, the first base 202 may have a sector shape to provide the first frame 200 with an arcuate appearance.

As shown in FIG. 19, the first base 202 has a pair of opposite ends. The underside of the first base 202 includes a first mounting plate 210a, and a second mounting plate 210b, each carrying first mover means for providing mobility to the first frame 200. The mounting plates 210 are identical to one another, and a secured to the bottom surface of the first base 202. The first mounting plate 210a is disposed adjacent one end of the first base 202, and the second mounting plate 210b is disposed adjacent the opposite end of the first base 202.

Each mounting plate 210 includes a pair of opposite ends, and a through-hole at each opposite end thereof for securing the first mover means to the mounting plate 210 (and therefore to the first base 202). Preferably, the first mover means comprises a pair of caster wheels (not shown) secured to the mounting plate 210, each secured to the mounting plate 210 through a respective one of the through-holes. Accordingly, when the first frame 200 is assembled, the first frame 200 includes a caster wheel disposed at each corner of the first base 202.

As shown in FIG. 16, the first upright support frame 204 includes a first end frame assembly 216, a second end frame assembly 218, and a fixed shelf 220 extending between the end frame assemblies 216, 218. The end frame assemblies 216, 218 are substantially identical to one another, and extend upright from the top surface of the first base 202 at substantially right angles to the first base 202.

In the embodiment shown, the first end frame assembly 216 is secured to the left hand end of the first base 202, above the mounting plate 210a. The second end frame assembly 218 is secured to the right hand end of the first base 202, above the mounting plate 210b. However, if the first frame 200 is disposed to the right of the second frame 300, the first end frame assembly 216 would be secured to the right hand end of the first base 202, and the second end frame assembly 218 would be secured to the left end of the first base 202. Hereafter, for convenience, the first end frame assembly 216 will be referenced as the left end frame assembly 216, and the second end frame assembly 218 will be referenced as the right end frame assembly 218.

For enhanced rigidity, preferably the end frame assemblies 216, 218 are welded to the first base 202. Alternately, however, for greater flexibility in shape/style, the end frame assemblies 216, 218 may be secured to the first base 202 with removable fasteners, such as steel screws or bolts, so as to allow the size of the first frame 200 to be altered by replacing the first base 202 with a different-sized first base 202.

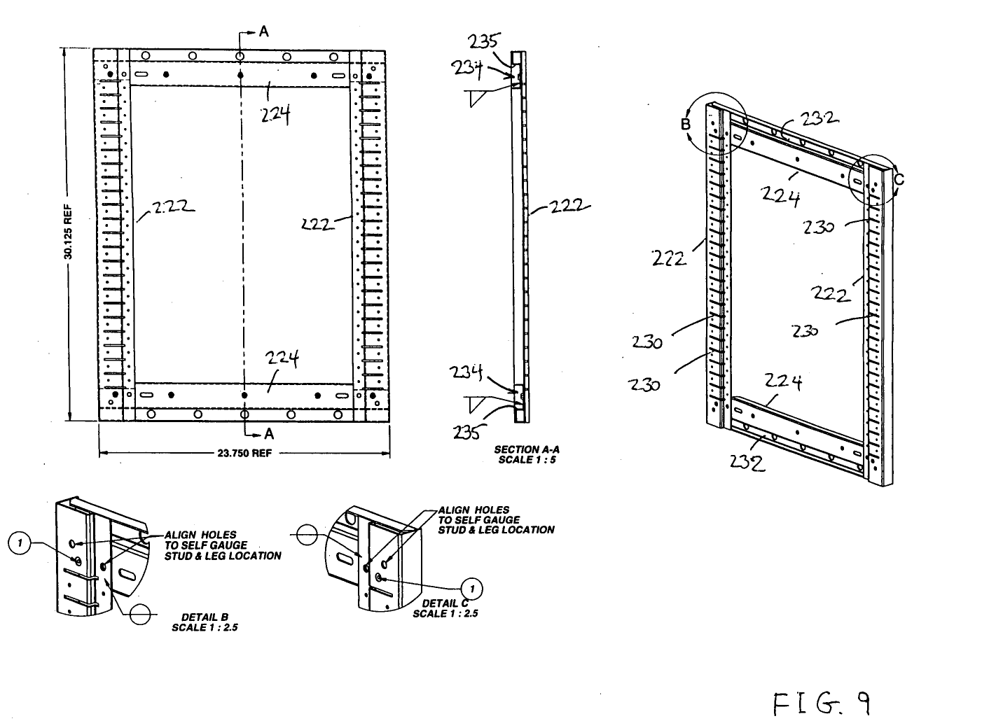

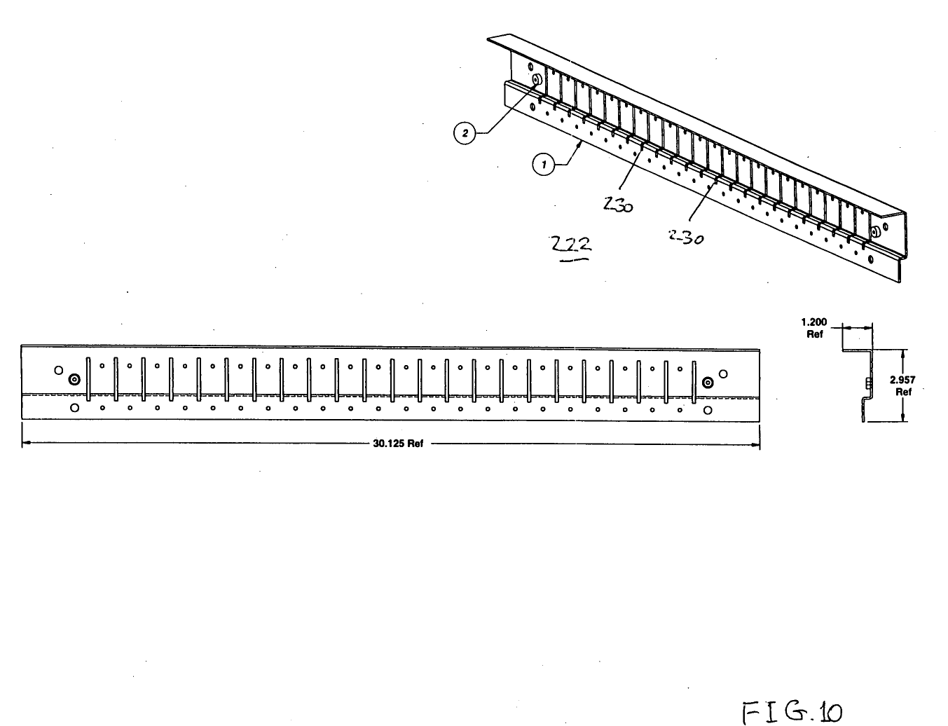

As shown in FIG. 9, the end frame assemblies 216, 218 each comprise a pair of elongate frame members 222, a pair of horizontal stud members 224, and a horizontal panel mounting bracket 228 (see FIG. 1). The elongate frame members 222 extend upwardly from adjacent corners of the first base 202, at substantially right angles to the first base 202. As shown in FIGS. 9, 10 and 16, each elongate frame member 222 includes a plurality of slots 230 disposed transversely to the longitudinal axis of the frame member 222. The slots 230 extend parallel to one another substantially along the entire length of the elongate frame member 222, and are sized to accept a corner of a movable shelf therein.

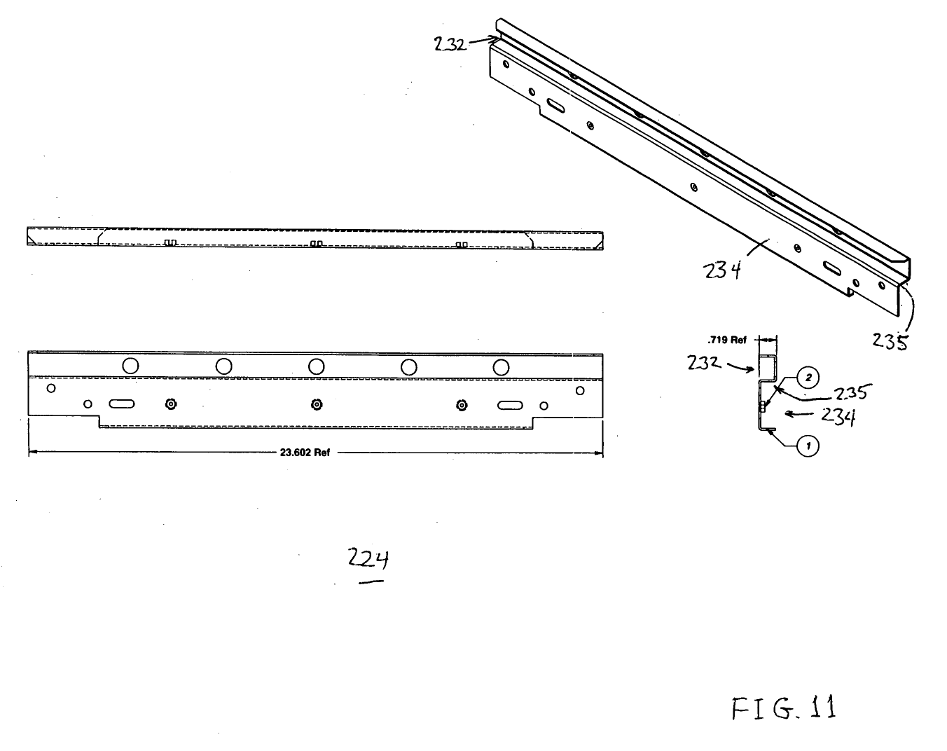

As shown in FIG. 11, each horizontal stud member 224 comprises a pair of opposing right-angled channels 232, 234. Each smaller channel 232 defines a stop 235 that extends outwardly from the frame members 222, substantially parallel to the first base 202. As will be explained, the stops 235 serve to secure the second frame 300 to the first frame 200.

The larger channel 234 includes a pair of through-holes which allow the stud member 224 to be secured to the elongate frame members 222 with removable fasteners, such as steel screws or bolts. Each horizontal stud member 224 extends horizontally between the pair of elongate frame members 222. One of the horizontal stud members 224 is fastened to the pair of elongate frame members 222 at one end thereof, and the other horizontal stud member 224 is fastened to the elongate frame members 222 at the other end. The horizontal stud members 224 are fastened to the elongate frame members 222 with an opposing orientation, such that the stop 235 of the upper horizontal stud member 224 is disposed at the uppermost end of the elongate frame members 222, adjacent the top 206, and the stop 235 of the lower horizontal stud member 224 is disposed at the lowermost end of the elongate frame members 222, adjacent the first base 202.

For enhanced rigidity, preferably the horizontal stud members 224 are welded to the elongate frame members 222, to thereby permanently secure the elongate frame members 222 together. Alternately, however, for greater flexibility in shape/style, the horizontal stud members 224 may be secured to the elongate frame members 222 with removable fasteners, such as steel screws or bolts, so as to allow the size of the first frame 200 to be altered.

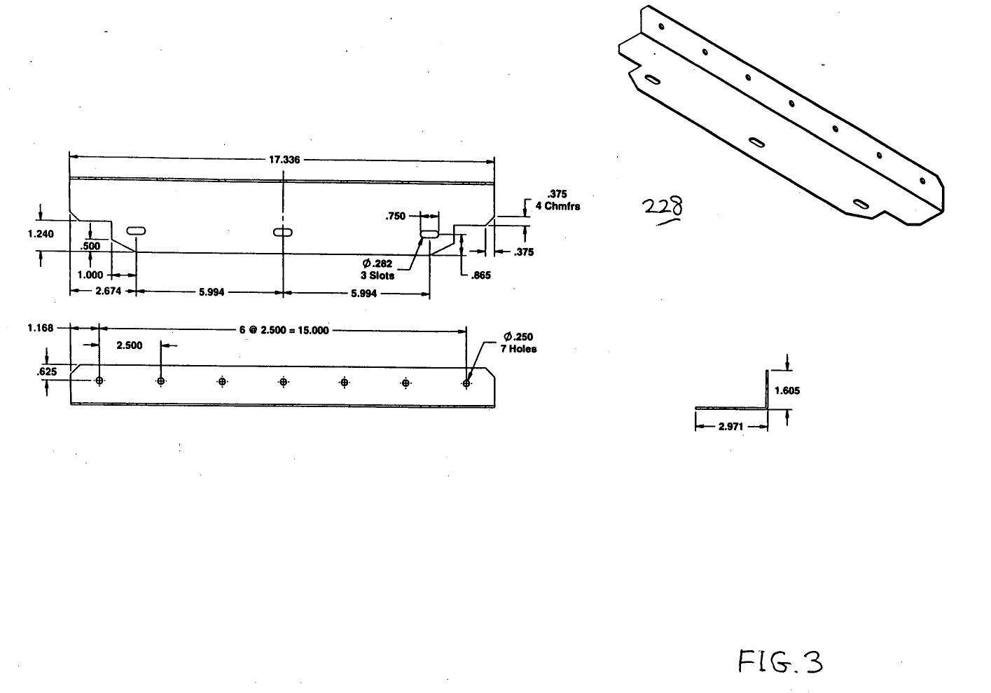

Each horizontal panel mounting bracket 228 is fastened to the upper horizontal stud member 224 at the uppermost end of the end frame assemblies 216, 218. As shown in FIG. 3, the horizontal panel mounting bracket 228 comprises a right-angle flange. One arm of the flange includes a plurality of through-holes for securing the mounting bracket 228 to the upper horizontal stud member 224 via removable fasteners, such as steel screws or bolts. Preferably, the through-holes are elongate to facilitate self-alignment of the horizontal panel mounting bracket 228 to the end frame assemblies 216, 218. The other arm of the flange includes a plurality of through-holes which allow the top panel 206 to be secured to the top of the first frame 200, via the horizontal panel mounting bracket 228.

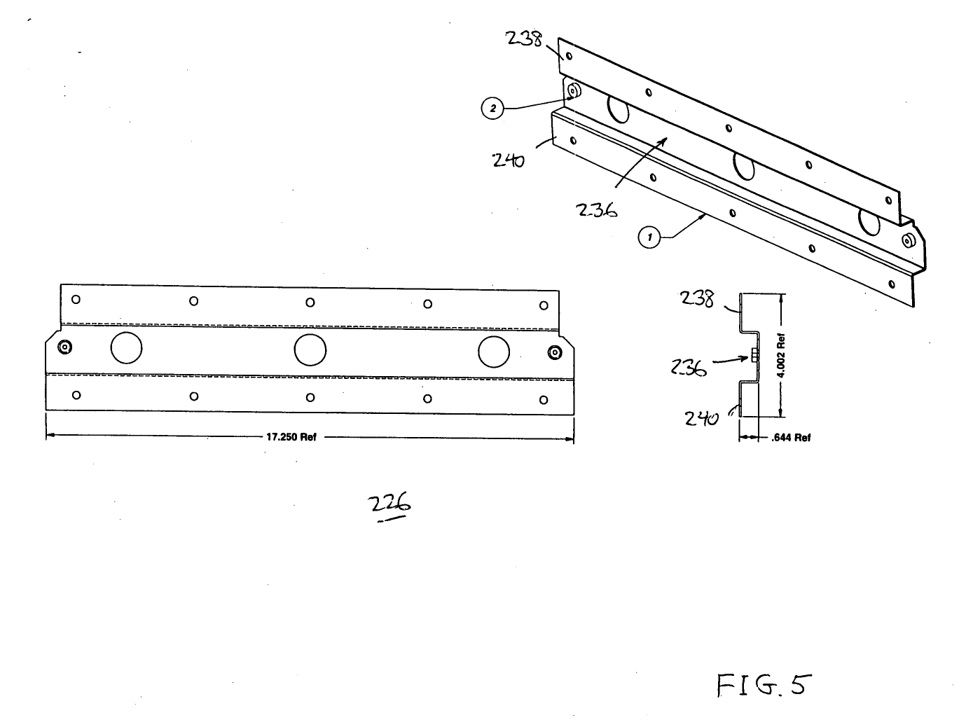

The left end frame assembly 216 includes an upper and a lower vertical panel mounting bracket 226 (the upper mounting bracket 226 is shown in FIG. 1; the lower mounting bracket 226 is not shown, but is identical to location to the lower mounting bracket 226 secured to the second frame 300). As shown in FIG. 5. each vertical panel mounting bracket 226 comprises a right-angle channel 236 terminating at each channel side in a pair of right-angle flanges 238, 240. The right-angle channel 236 is oriented vertically, and includes a plurality of through-holes for securing the panel mounting bracket 226 to one of the horizontal stud members 224 with removable fasteners, such as bolts. Similarly, the right-angle flanges 238, 240 are oriented vertically, and include a plurality of through-holes which allow the vertically-extending panels 208 to be secured to the sides of the first frame 200, via the panel mounting brackets 226.

Each vertical panel mounting bracket 226 extends horizontally between the elongate frame members 222, and is secured to the larger channel 234 of one of the horizontal stud members 224. As a result, one of the panel mounting brackets 226 is disposed at the uppermost end of the elongate frame members 222, adjacent the top 206, and the other panel mounting bracket 226 is disposed at the lowermost end of the elongate frame members 222, adjacent the first base 202.

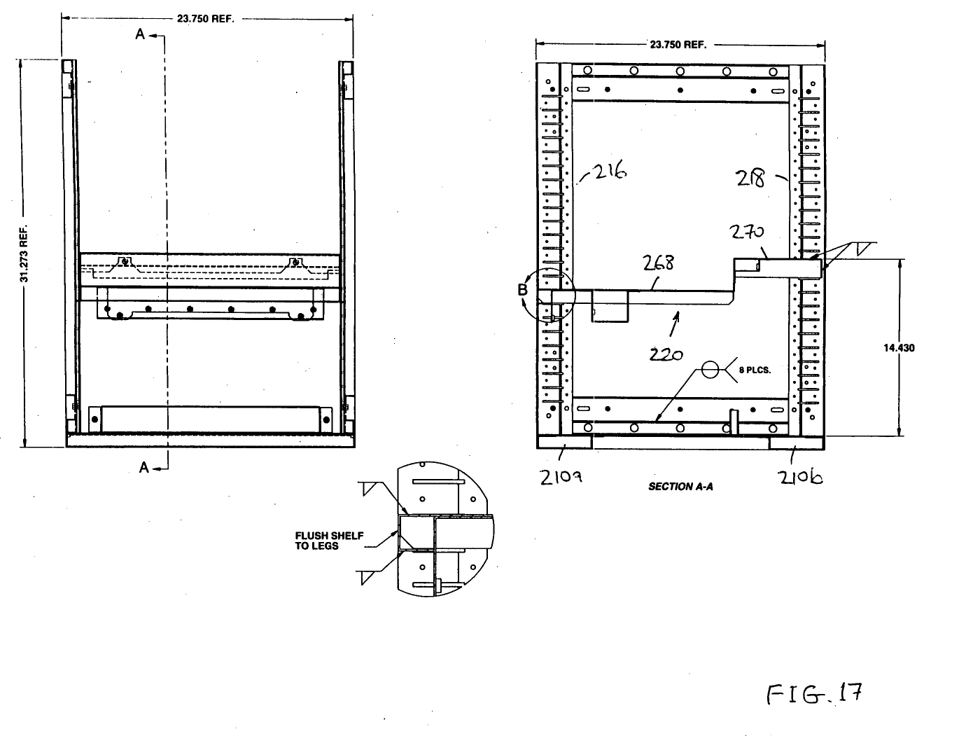

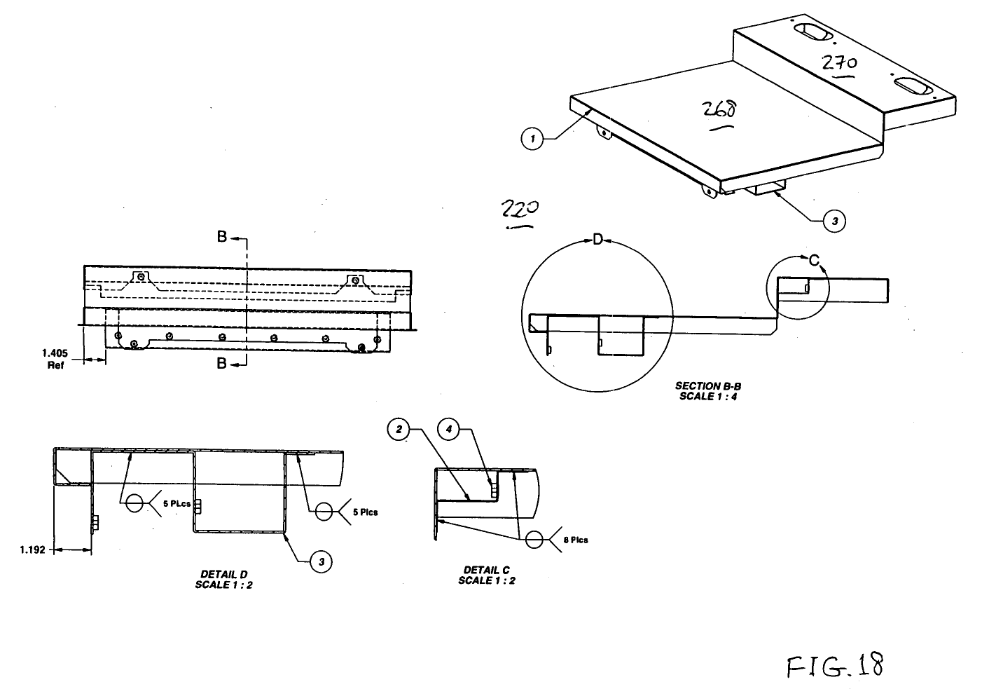

As shown in FIGS. 1, 16, and 17, the shelf 220 extends horizontally between the end frame assemblies 216, 218, above the first base 202, below the horizontal panel mounting brackets 228. As shown in FIG. 18, the shelf 220 is substantially rectangular in shape, and includes a left hand end and right hand end. The shelf 220 also includes a first step 268, and a second step 270 extending upwards from the rear of the first step 268. The shelf 220 is secured at the left hand end to the elongate frame members 222 of the left end frame assembly 216, and is secured at the right hand end to the elongate frame members 222 of the right end frame assembly 218.

For enhanced rigidity, preferably the shelf 220 is welded at its four corners to the elongate frame members 222, thereby securing the end frame assemblies 216, 218 together. Alternately, however, for greater flexibility in shape/style, the shelf 220 may be secured to the end frame assemblies 216, 218 with removable fasteners, such as steel screws or bolts, so as to allow the size of the first frame 200 to be altered by replacing the shelf 220 (and the first base 202) with a different-sized shelf 220 (and first base 202).

Second Frame 300

The second frame 300 includes a second base 302, and a second upright support frame 304 extending upwardly from the second base 302 for supporting a top and vertically-extending side/rear panels 208 (see FIG. 20). The top supported by the second upright support frame 304 is typically the same continuous panel as the top 206 supported by the first upright support frame member 204, however it can also be a panel separate from the top 206.

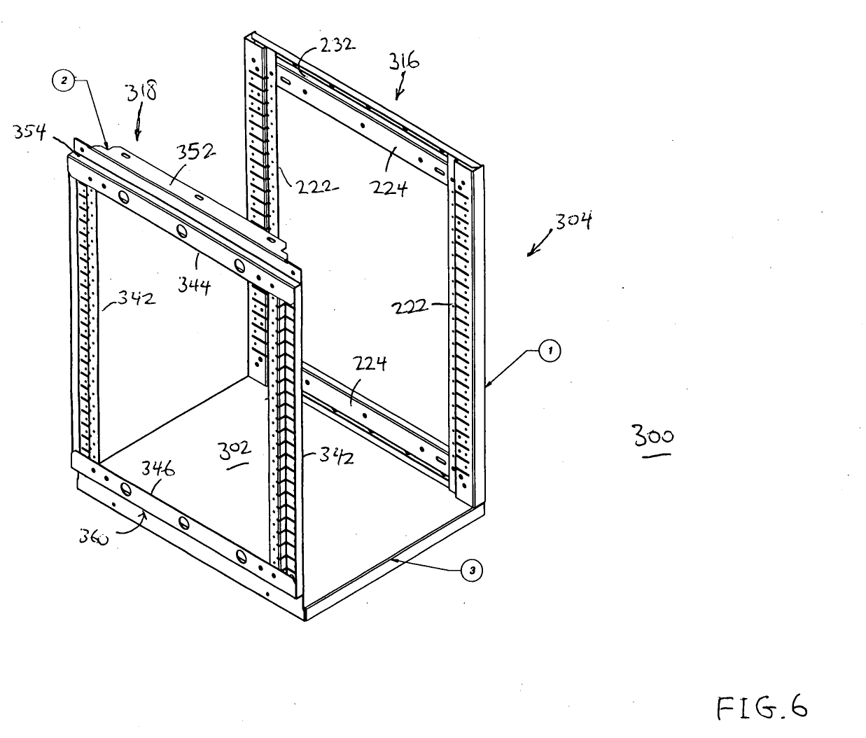

The second base 302 and the second upright support frame 304 are shown in detail in FIGS. 6, 7 and 8. Preferably, the second frame 300 has a substantially parallelopiped shape, and the second base 302 has a substantially rectangular shape. Alternately, however, the second base 302 and the second frame 300 may have a different shape to impart a different appearance to the first frame 300. For instance, the second base 302 may have a sector shape to provide the second frame 300 with an arcuate appearance.

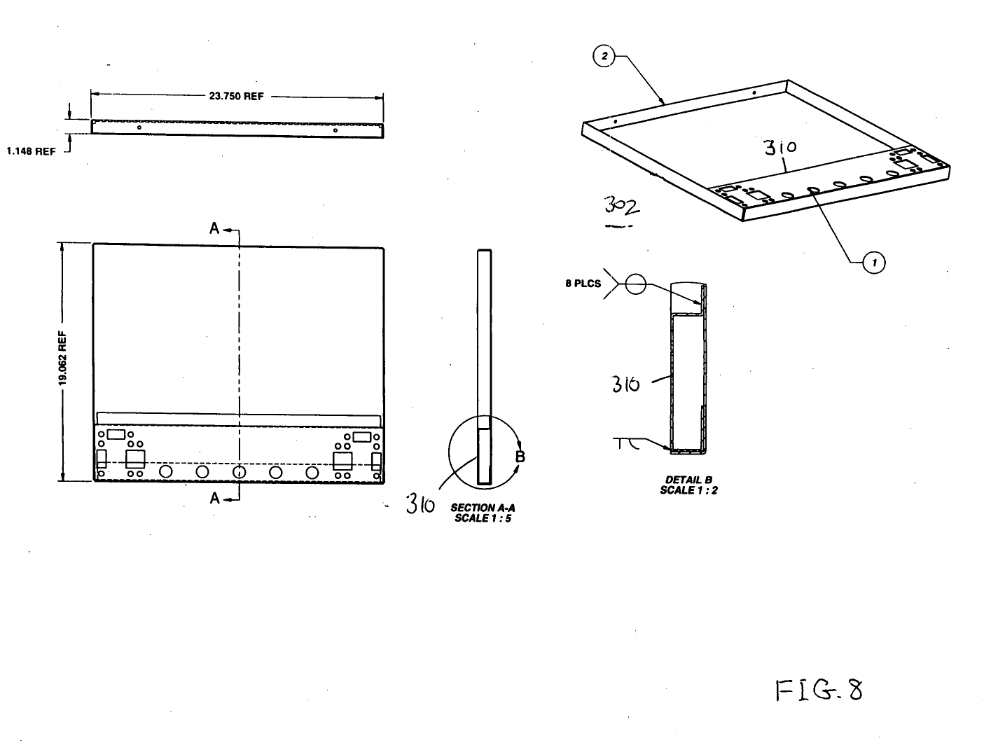

As shown in FIG. 8, the underside of the second base 302 includes a mounting plate 310 disposed at one end of the second base 302 for securing second mover means to the second base 302 for providing mobility to the second frame 300. Preferably, the second mover means comprises a pair of caster wheels (not shown) secured to the mounting plate 310, each disposed at opposite ends of the mounting plate 310.

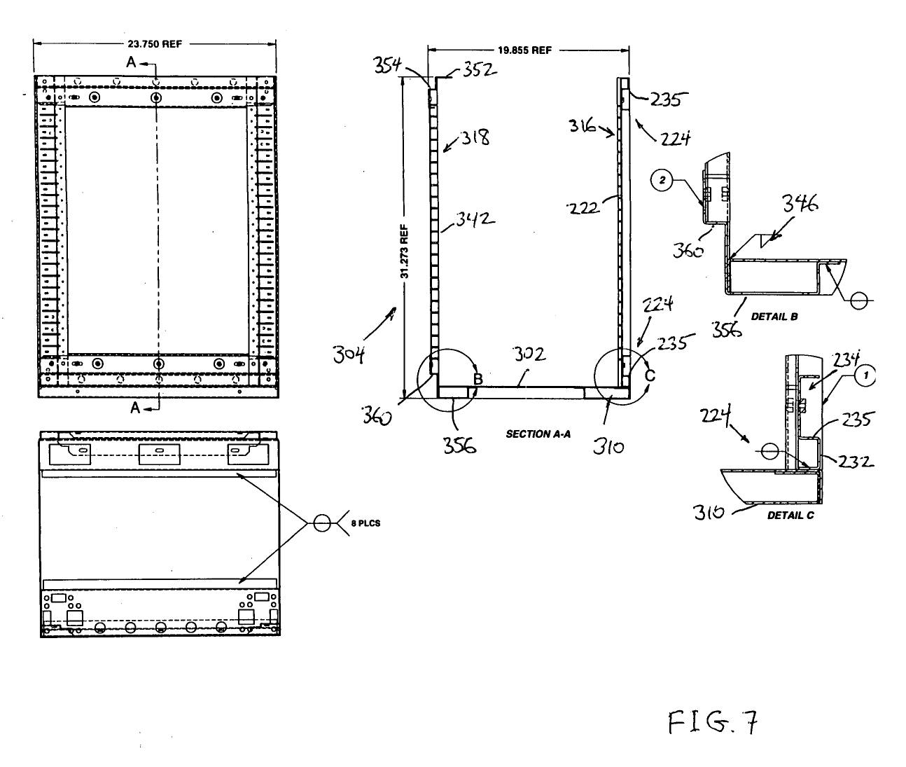

As shown in FIGS. 6 and 7, the second upright support frame 304 includes a first end frame assembly 316, and a second end frame assembly 318. Further, as shown in FIG. 1, the second upright support frame 304 also includes upper and lower back frame braces 320 extending between the first and second end frame assemblies 316, 318. The end frame assemblies 316, 318 both extend upright from the second base 302 at substantially right angles to the second base 302. The first end frame assembly 316 is secured to one end of the second base 302, and the second end frame assembly 316 is secured to the opposite end of the second base 302.

For enhanced rigidity, preferably the end frame assemblies 316, 318 are welded to the second base 302. Alternately, however, for greater flexibility in shape/style, the end frame assemblies 316, 318 may be secured to the second base 302 with removable fasteners, such as steel screws or bolts, so as to allow the size of the second frame 300 to be altered by replacing the second base 302 with a different-sized second base 302.

In the embodiment shown, the first end frame assembly 316 is secured to the right hand end of the second base 302, above the mounting plate 310, and the second end frame assembly 318 is secured to the left end of the second base 302. However, if the first frame 200 is disposed to the right of the second frame 300, the first end frame assembly 316 would be secured to the left hand end of the second base 302, and the second end frame assembly 318 would be secured to the right end of the second base 302. Hereafter, for convenience, the first end frame assembly 316 will be referenced as the right end frame assembly 316, and the second end frame assembly 318 will be referenced as the left end frame assembly 318.

The right end frame assembly 316 is identical to the left end frame assembly 216 of the first frame 200. The right end frame assembly 316 comprises a pair of the elongate frame members 222, a pair of the horizontal stud members 224, a pair of the vertical panel mounting brackets 226, and the horizontal panel mounting bracket 228. The elongate frame members 322 extend upwardly from adjacent corners of the second base 302, at substantially right angles to the second base 302. As shown in FIGS. 6, 9 and 10, each elongate frame member 222 includes a plurality of slots 230 disposed transversely to the longitudinal axis of the frame member 222. The slots 230 extend parallel to one another substantially along the entire length of the elongate frame member 222, and are sized to accept a corner of a movable shelf therein.

As discussed above with reference to FIG. 11, each horizontal stud member 224 comprises a pair of opposing right-angled channels 232, 234. As discussed above, the smaller channel 232 defines a stop 235 which serves to secure the second frame 300 to the first frame 200. Each horizontal stud member 224 extends horizontally between the pair of elongate frame members 222. The horizontal stud members 224 are fastened to the elongate frame members 222 with an opposing orientation, such that the stop 235 of the upper horizontal stud member 224 is disposed at the uppermost end of the elongate frame members 222, adjacent the top 206′, and the stop 235 of the lower horizontal stud member 224 is disposed at the lowermost end of the elongate frame members 222, adjacent the second base 302.

For enhanced rigidity, preferably the horizontal stud members 224 are welded to the elongate frame members 222, to thereby permanently secure the elongate frame members 222 together. Alternately, however, for greater flexibility in shape/style, the horizontal stud members 224 may be secured to the elongate frame members 222 with removable fasteners, such as steel screws or bolts, so as to allow the size of the second frame 300 to be altered.

As discussed above with reference to FIG. 5, each vertical panel mounting bracket 226 comprises a right-angle channel 236 terminating at each channel side in a pair of right-angle flanges 238, 240. Each vertical panel mounting bracket 226 extends horizontally between the elongate frame members 222, and is secured to the larger channel 234 of one of the horizontal stud members 224. As a result, one of the panel mounting brackets 226 is disposed at the uppermost end of the elongate frame members 222, adjacent the top 206′, and the other panel mounting bracket 226 is disposed at the lowermost end of the elongate frame members 222, adjacent the second base 302.

The horizontal panel mounting bracket 228 is fastened to the upper horizontal stud member 224 at the uppermost end of the right end frame assembly 316, opposite the similarly-located vertical panel mounting bracket 226.

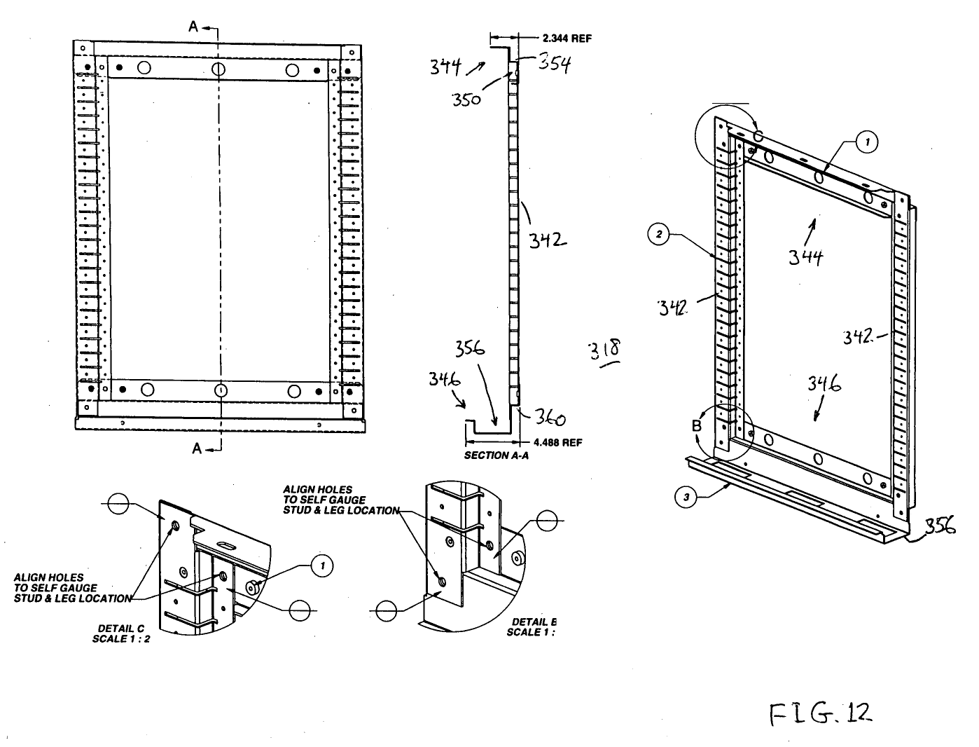

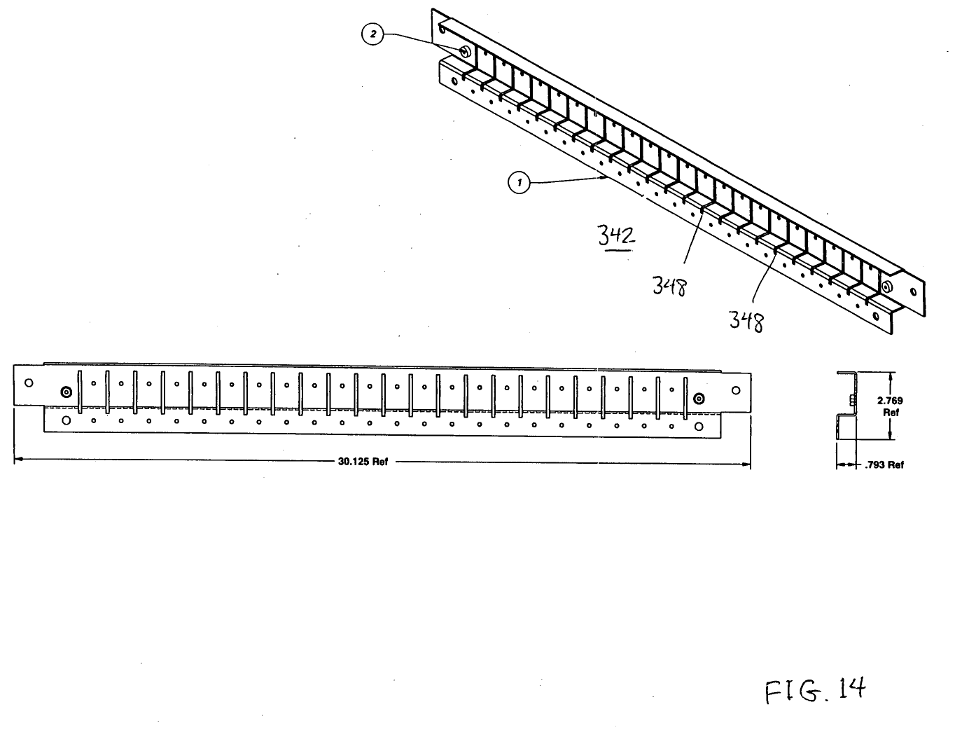

The left end frame assembly 318 comprises a pair of elongate frame members 342, an upper horizontal stud member 344, and a lower horizontal stud member 346. The elongate frame members 342 extend upwardly from adjacent corners of the second base 302, at substantially right angles to the second base 302. As shown in FIGS. 6, 12 and 14, each elongate frame member 342 includes a plurality of slots 348 disposed transversely to the axis of the frame member 342. The slots 348 extend parallel to one another substantially along the entire length of the elongate frame member 342, and are sized to accept a corner of a movable shelf therein.

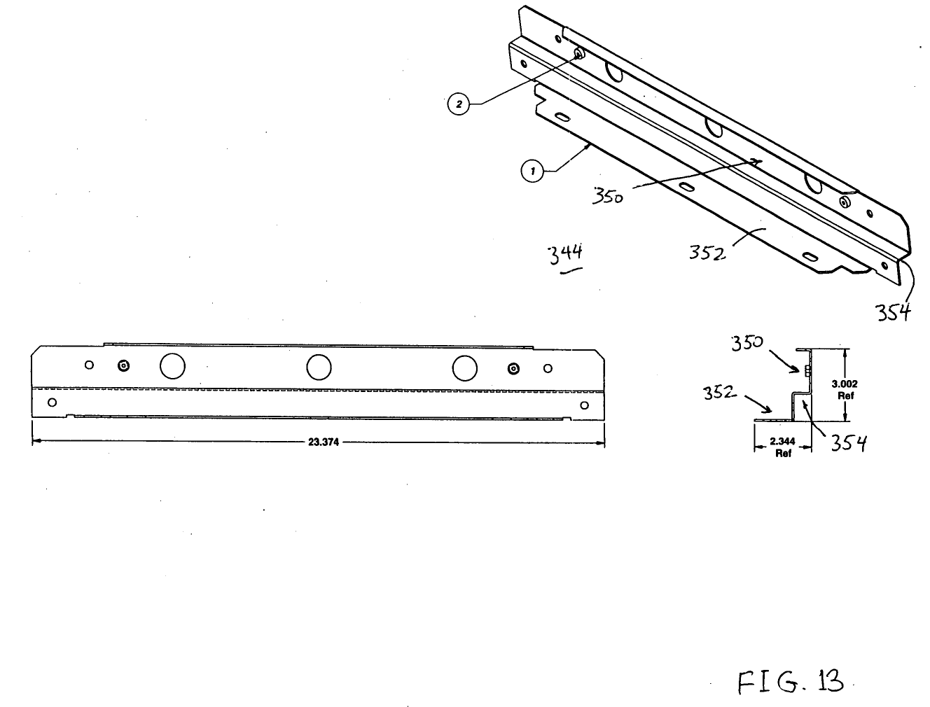

As shown in FIG. 13, the upper horizontal stud member 344 comprises a right-angled channel 350 terminating in a right-angle flange 352. The right-angled channel 350 defines a shoulder 354 that extends outwardly from the frame members 342, substantially parallel to the second base 302. The right-angle flange 352 includes a plurality of through-holes which allow the top 206′ to be secured to the upper horizontal stud member 344. Preferably, the top 206′ is secured to the upper horizontal stud member 344 with removable fasteners, such as steel screws or bolts. Further, preferably the through-holes are elongate to facilitate self-alignment of the top 206′ to the left end frame assembly 318.

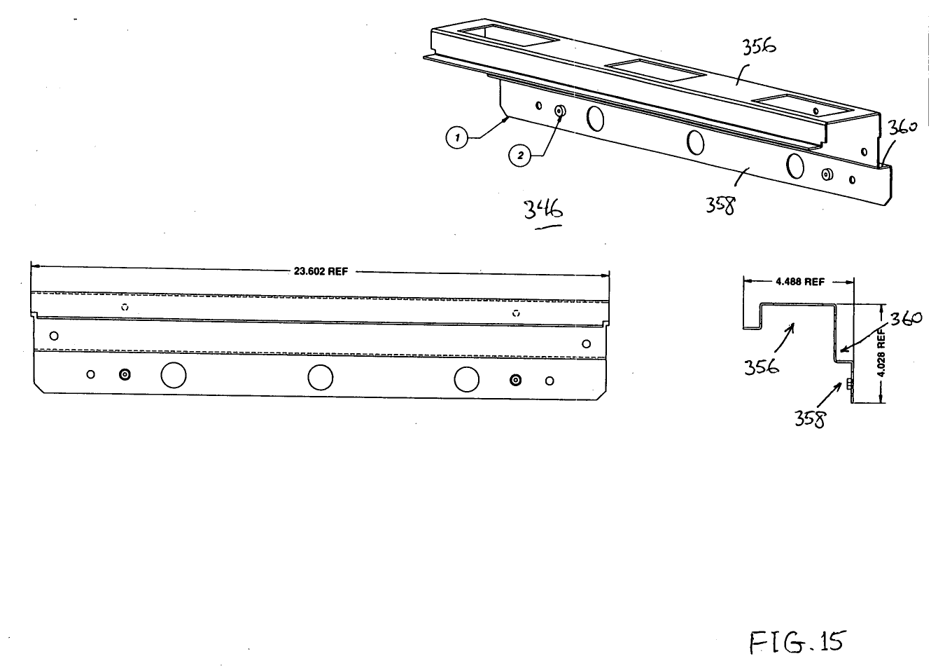

As shown in FIG. 15, the lower horizontal stud member 346 comprises a right-angled channel 356 terminating in a right-angle flange 358. The right-angled channel 356 includes a laterally-extending portion which serves to support the second base 302. The right-angle flange 358 includes a plurality of through-holes which allow the stud member 346 to be secured to the pair of elongate frame members 342 with removable fasteners, such as steel screws or bolts. Also, the right-angle flange 358 defines a shoulder 360 that extends outwardly from the frame members 342, substantially parallel to the second base 302.

The upper horizontal stud member 344 is fastened to the elongate frame members 342 at one end thereof, and the lower horizontal stud member 346 is fastened to the elongate frame members 342 at the other end. The upper and lower horizontal stud members 344, 346 are fastened to the elongate frame members 342 with an opposing orientation, such that the shoulder 354 of the upper horizontal stud member 344 is disposed near the uppermost end of the elongate frame members 342, adjacent the top 206′, and the shoulder 360 of the lower horizontal stud member 346 is disposed near the lowermost end of the elongate frame members 342, adjacent the second base 302.

For enhanced rigidity, preferably the horizontal stud members 344, 346 are welded to the elongate frame members 342, to thereby permanently secure the elongate frame members 342 together. Alternately, however, for greater flexibility in shape/style, the horizontal stud members 344, 346 may be secured to the elongate frame members 342 with removable fasteners, such as steel screws or bolts, so as to allow the size of the second frame 300 to be altered.

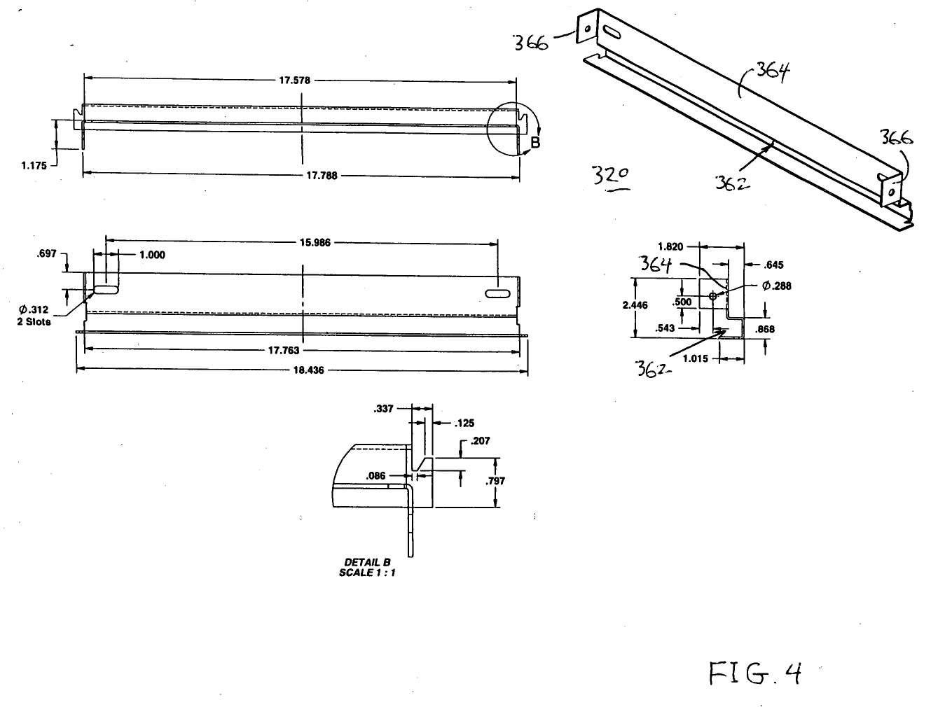

The back frame braces 320 extend horizontally between the end frame assemblies 316, 318, securing the end frame assemblies 316, 318 together. As shown in FIG. 4, each back frame brace 320 comprises a right-angled channel 362 terminating in a right-angle flange 364. The right-angled channel 362 includes laterally-extending edges that engage the slots 330, 348 of the elongate frame members 322, 342. The right-angle flange 364 includes flaps 366 that are disposed at opposite ends of the brace 320 and extend at a right angle to the right-angle flange 364. Each flap 366 includes a through-hole that allows the back frame brace 320 to be secured to the end frame assemblies 316, 318, via the elongate frame members 322. As shown, one of the flaps 366 is used to secure the back frame brace 320 to the rearward elongate frame member 322 of the right end frame assembly 316, and the other flap 366 is used to secure the back frame brace 320 to the rearward elongate frame member 342 of the left end frame assembly 318.

One of the back frame braces 320 is fastened to the elongate frame members 222, 342 at one end thereof, and the other back frame brace 320 is fastened to the elongate frame members 222, 342 at the other end. As a result, one of the back frame braces 320 is disposed at the uppermost end of the elongate frame members 222, 342 adjacent the top 206′, and the other back frame brace 320 is disposed at the lowermost end of the elongate frame members 222, 342 adjacent the second base 302.

Preferably, the back frame braces 320 secured to the elongate frame members 222, 342 with removable fasteners, such as steel screws or bolts. Alternately, however, for enhanced rigidity, for greater flexibility in shape/style, the back frame braces 320 may be welded to the elongate frame members 222, 342, to thereby permanently secure the end frame assemblies 316, 318 together.

One of the aforementioned vertically-oriented panel mounting brackets 226 is secured to the right-angle flange 364 of each back frame brace 320 for allowing one of the vertically-extending panels 208 to be secured to the rear of the second frame 300.

Assembly of the Mobile Cart 100

To assembly the mobile cart 100, the assembler obtains one of the first frames 200 and one of the second frames 300, and then directs the second frame 300 against the first frame 200 such that the left end frame assembly 318 of the second frame 300 is pressed against the right end frame assembly 318 of the first frame 200. In this position, the shoulder 354 of the upper horizontal stud member 344 of the left end frame assembly 316 of the second frame 300 is positioned below the upper stop 235 of the right end frame assembly 218 of the first frame 200. Conversely, the shoulder 360 of the lower horizontal stud member 346 of the left end frame assembly 316 of the second frame 300 is positioned above the lower stop 235 of the right end frame assembly 218 of the first frame 200. As such, the shoulders 354, 360 are disposed vertically between the stops 235.

Thus, when the left end frame assembly 318 of the second frame 300 is pressed against the right end frame assembly 318 of the first frame 200, the shoulder 354 frictionally engages the upper stop 235, and the shoulder 360 frictionally engages the lower stop 235, thereby helping to secure the second frame 300 to the first frame 200. Further, the lower stop 235 supports the shoulder 360, so that a portion of the load carried by the second frame 300 is carried by the first frame 200. Removable fasteners, such as steel screws or bolts, are then threaded between the elongate frame members 222 of the right end frame assembly 218 of the first frame 200, and the elongate frame members 342 of the left end frame assembly 318 of the second frame 300, thereby rigidly securing the second frame 300 to the first frame 200.

The horizontal tops 206, 206′ (FIG. 21) and the vertically-extending side/rear panels 208 (FIG. 20) comprise board facia paneling. Further, the horizontal panels 206, 206′ and the vertical panels 208 each include a mounting plate (not shown) fastened thereto for removably securing the paneling to the respective panel mounting brackets 226, 228. Thus, after the second frame 300 is secured to the first frame 200, the horizontal tops 206, 206′ and the vertically-extending side/rear panels 208 are secured to the mobile cart 100 using removable fasteners, such as wood screws. As discussed above, the top 206′ carried by the second frame 300 is typically the same continuous panel as the top 206 supported by the first frame 200, however it can also be a panel separate from the top 206. If the top 206′ is separate from the top 206, typically the top 206′ is substantially coplanar with the top 206.

This foregoing arrangement is advantageous since vertical movement of the second frame 300 relative to the first frame 200 is limited by the shoulders 354, 360 engaging the stops 235, thereby limiting the shear forces acting on the removable fasteners. Further, since the mobile cart 100 is support by mover means (eg. caster wheels) near the right end frame assembly 218 of the first frame 200, and is also support by mover means near the left end frame assembly 216 of the first frame 200 and the right end frame assembly 316 of the second frame 300, the mobile cart 100 exhibits improved pivoting capabilities in comparison to conventional mobile carts.

Further, the assembler can obtain another second frame 300, and secure the left end frame assembly 318 of the new second frame 300 to the right end frame assembly 316 of the second frame 300 that is already secured to the first frame 200. Additional second frames 300 can be cascaded together, in this manner, thereby allowing the assembler to increase the length of the mobile cart 100 simply by added additional second frames 300. The assembly can also secure the left end frame assembly 318 of a new second frame 300 to the left end frame assembly 216 of the first frame 200, thereby allowing the assembler to extend the length of the mobile cart 100 to the left and/or the right hand end of the first frame 200.

Also, since the panels 206, 206′, 208 include one or more mounting plates, the panels 206, 206′, 208 can be precisely fitted to the mobile cart 100 without significant manual effort. In addition, the mounting plates allow the panels 206, 206′, 208 to be easily replaced with different panels 206, 206′, 208, as the decorative needs of the owner of the mobile cart 100 change.

The present invention is defined by the claims appended hereto, with the foregoing description being illustrative of preferred embodiments of the invention. Persons of ordinary skill may envisage certain modifications to the described embodiments which, although not explicitly described or suggested herein, do not depart from the scope of the invention, as defined by the appended claims.

1. A mobile cart comprising:
a first frame comprising a first base, first mover means coupled to the first base for providing mobility to the first frame, and a first upright support frame extending upwardly from the first base for supporting a first top, the first support frame including first engagement means; and
a second frame comprising a second base, second mover means coupled to the second base for providing mobility to the second frame, and a second upright support frame extending upwardly from the second base for supporting a second top, the second support frame including second engagement means cooperating with the primary engagement means for securing the second frame to the primary frame.

2. The mobile cart according to claim 1, wherein the first engagement means comprises a pair of stops, one of the stops being disposed adjacent the first base, the other of the stops being disposed adjacent the first top, and the second engagement means comprises a pair of shoulders, one of the shoulders being disposed adjacent the second base, the other of the shoulders being disposed adjacent the second top, the shoulders pressing against the stops for securing the second frame to the first frame.

3. The mobile cart according to claim 2, wherein the stops are positioned at opposite ends of the first upright support frame, and the shoulders are positioned at opposite ends of the second upright support frame, the shoulders being disposed between the stops.

4. The mobile cart according to claim 3, wherein the stops and the shoulders extend outwardly from the respective upright support frames, substantially parallel to the base.

5. The mobile cart according to claim 4, wherein the first frame has a substantially parallelopiped shape, the first base has four corners, and the first mover means comprises a caster wheel disposed at each respective corner.

6. The mobile cart according to claim 5, wherein each upright support frame comprises four elongate frame members, each said frame member including a plurality of parallel slots extending substantially parallel to the respective base for supporting movable shelving therein.

7. The mobile cart according to claim 6, wherein each said shoulder is formed on a respective substantially horizontally-extending second stud panel, the second stud panels being secured to a pair of the respective elongate frame members, an uppermost one of the second stud panels being configured for removably securing the second top thereto, a lowermost one of the stud panels including a channel for supporting a portion of the second base.

8. The mobile cart according to claim 7, wherein each said stop is formed on a respective substantially horizontally-extending first stud panel, the first stud panels being secured to a pair of the respective elongate frame members, an uppermost one of the first stud panels being configured for removably securing the first top thereto, the second top being substantially coplanar with the first top.

9. The mobile cart according to claim 8, wherein the first and second tops comprise board facia paneling.

10. The mobile cart according to claim 6, wherein the upright support frames include a panel mounting bracket fastened thereto for securing substantially vertically-extending side facia paneling to the support frames.

11. The mobile cart according to claim 10, wherein the facia paneling includes a mounting plate fastened thereto for removably securing the paneling to the respective panel mounting bracket.

12. A mobile cart comprising:
a base;
mover means coupled to the base for providing mobility to the cart;
a top; and
a support frame extending upwardly from the base and supporting the top, the upright support frame including engagement means for securing an auxiliary cart to the mobile cart.

13. The mobile cart according to claim 12, wherein the engagement means comprises a pair of stops, one of the stops being disposed adjacent the base, the other of the stops being disposed adjacent the top, and the auxiliary cart includes a pair of shoulders, one of the shoulders being disposed adjacent a base of the auxiliary cart, the other of the shoulders being disposed adjacent a top of the auxiliary cart, the stops being disposed for pressing against the stops for securing the auxiliary cart to the mobile cart.

14. The mobile cart according to claim 13, wherein the stops are positioned at opposite ends of the support frame, and the shoulders are disposed between the stops.

15. The mobile cart according to claim 14, wherein the support frame comprises a plurality of elongate frame members, and the stops extend outwardly from the frame members, substantially parallel to the base.

16. The mobile cart according to claim 15, wherein the support frame has a substantially parallelopiped shape, the base has four corners, and the mover means comprises a caster wheel disposed at each respective corner.

17. The mobile cart according to claim 16, wherein each said frame member includes a plurality of parallel slots extending substantially parallel to the base for supporting movable shelving therein.

18. The mobile cart according to claim 17, wherein each said stop is formed on a respective substantially horizontally-extending stud panel, the stud panels being secured to a pair of the elongate frame members, an uppermost one of the stud panels being configured for removably securing the top to the respective elongate frame members.

19. The mobile cart according to claim 18, wherein the top comprises board facia paneling.

20. The mobile cart according to claim 15, wherein each said shoulder is formed on a respective substantially horizontally-extending stud panel, the stud panels being secured to a pair of the elongate frame members, an uppermost one of the stud panels being configured for removably securing the top of the auxiliary cart to the respective elongate frame members, a lowermost one of the stud panels including a channel for supporting a portion of the base of the auxiliary cart.

21. The mobile cart according to claim 15, wherein the upright frame members include a panel mounting bracket fastened thereto for securing substantially vertically-extending side facia paneling to the frame members.

22. The mobile cart according to claim 21, wherein the facia paneling includes a mounting plate fastened thereto for removably securing the paneling to the respective panel mounting bracket.
